(19) United States
(12) Patent Application Publication
(10) Pub. No.: US 2010/0224037 A1
(43) Pub. Date: Sep. 9, 2010

(54) Disassembling tool for air hose

(75) Inventors: Yu-Feng Ding, Taichung City (TW); Chien-Chou Lin, Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/380,797

(22) Filed: Mar. 4, 2009

(51) Int. Cl. B25B 7/04

(52) U.S. Cl. 81/343

(57) ABSTRACT

A disassembling tool for an air hose is proposed. The tool has two pivotally connoted members. When drawn together, the two members jointly provide at least one air-hose hole that allows the air hose to pass through. By using the tool to press upon a joint of an air compressor, the air hose assembled in the air hose can be easily disassembled from the joint.

### BACKGROUND OF THE INVENTION

1. Technical Field

The present invention relates to a tool that facilitates disassembling an air hose from a joint of an air compressor.

2. Description of Related Art

Referring to FIGS. 1 and 2, a conventional joint 10 provided on an air compressor comprises a hollow fixing member 11 fixedly attached to a body of an electromagnetic valve of the air compressor, an airtight ring 12 received in the hollow fixing member 11, a hollow positioning member 13 fixed in the hollow fixing member 11 and abutting on the airtight ring 12, a retaining ring 14 positioned in the hollow positioning member 13 and having resilient hooks 141, and an ejection member 15 shiftably set in the positioning member 13. To assemble the conventional joint 10 with a flexible air hose 16, the air hose 16 pierces through the ejection member 15 and reach the positioning member 13. Then when passing by the retaining ring 14, the air hose 16 pushes the resilient hooks 141 outward so that the air hose 16 pierces through the airtight ring 12 and abuts on the fixing member 11. Afterward, the resilient hooks 141 return to the initial positions thereof and engage the air hose 16. To disassemble the air hose 16 from the joint 10, the ejection member 15 is firstly pushed inward the positioning member 13 so that a pushing end 132 of the positioning member 13 pushes the resilient hooks 141 outward to disengage the air hose 16 and then the air hose 16 can be withdrawn from the joint 10.

However, once the air compressor is actuated and the air pressure therein gets increased, the air hose filled with air becomes expanded and hardened rendering increased tightness of the combination of the airtight ring 12, the resilient hooks 141, the positioning member 13 and the ejection member 15. As a result, it would be a difficult task to disassemble the air hose 16 from the joint 10 because the ejection member 15 has an annular surface 151 too small in area for a user to push barehanded to surmount the afore said tight combination. One traditional solution is to implement a screwdriver or a vise to press the ejection member 15, and forcibly pull the air hose 16 outward at the same time. The traditional solution nevertheless has some defects.

First, the prerequisite of the traditional solution is that the ejection member 15 provides enough area for the hand tool to thrust.

Even the ejection member 15 provides enough area, the above-mentioned screw driver or vise tends not to exert a pressure evenly over the ejection member 15, thus causing the ejection member 15 moving bias and the resilient hooks 141 opened asymmetrically. As long as any of the resilient hooks 141 does not disengage the air hose 16, the air hose is still caught by the retaining ring 14.

At this time, if the air hose 16 is forcedly pulled outward, the airtight ring 12 and the resilient hooks 141 may be damaged, and even the operator may get hurt.

### SUMMARY OF THE INVENTION

In view of the shortcomings of the prior art, the present invention herein provides a tool that facilitates disassembling an air hose from a joint of an air compressor. The tool evenly distributes a pressing force from an operator thereof to an ejection member of the joint, so as to make the air hose fully disengaged from all components inside the joint. By the disclosed tool, even when the air compressor is actuated and the air pressure in the air hose gets increased, an operator is enabled to safely and easily disassemble the air hose from the joint while both the joint and the air hose are better protected from being damaged under forced disassembling operation.

The disclosed disassembling tool for an air hose comprises: a first member, and a second member pivotally connected with the first member through a pin, wherein a plurality of semicircular first recesses are provided at surfaces of the first and second members facing each other and each of the first recesses is opened at two laterals of the first member or the second member, whereby when the first member and the second member are drawn together with the first recesses thereon combined mutually, each two said combined first recesses form an air-hose hole.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a conventional joint of an air compressor holding an air hose;

FIG. 2 is a sectional view of the conventional joint with the air hose assembled therein;

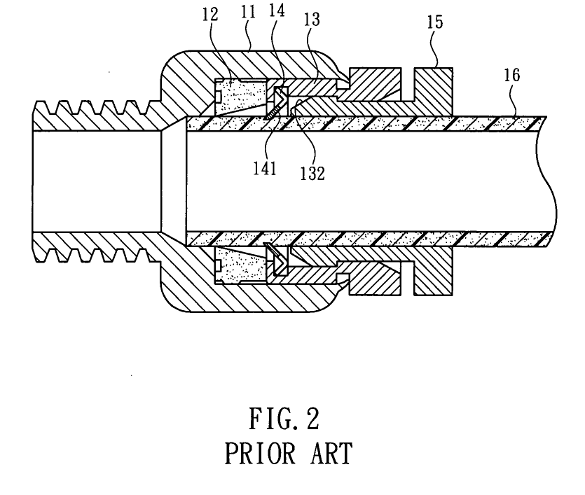

FIG. 3 is a front perspective view of a disassembling tool of the present invention;

FIG. 4 is a rear perspective view of the disassembling tool of the present invention;

FIG. 5 is a schematic drawing showing the disassembling tool disassembling the air hose from the joint in a first operation mode; and

FIG. 6 is a schematic drawing showing the disassembling tool disassembling the air hose from the joint in a second operation mode.

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

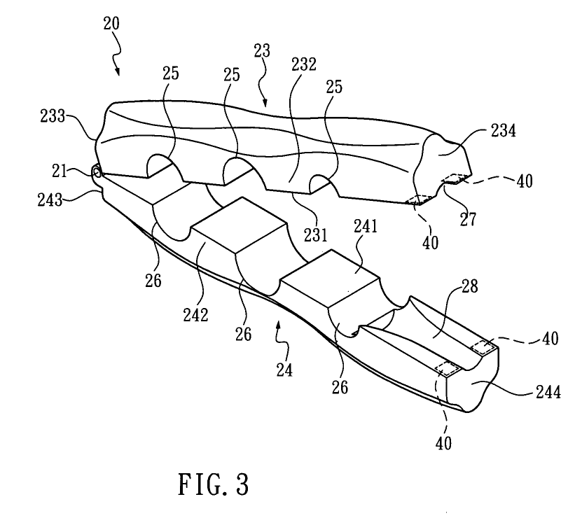

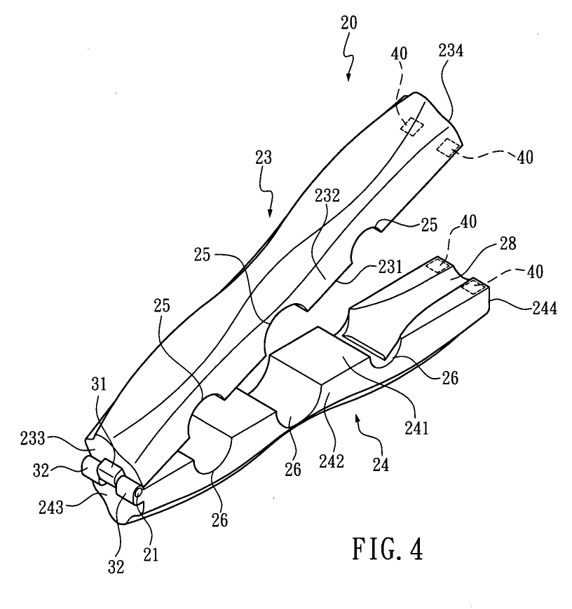

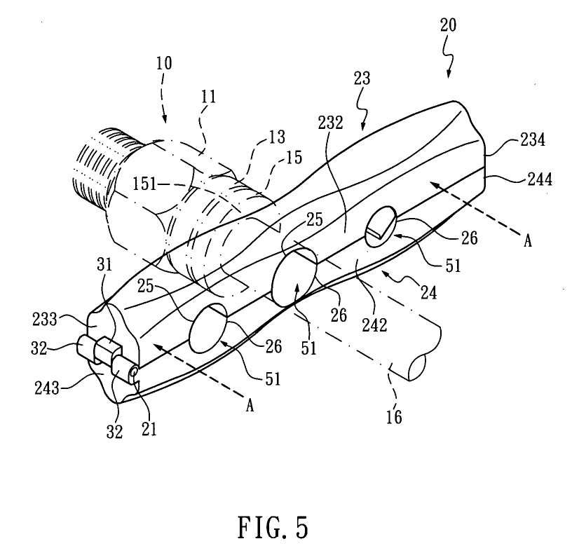

Please refer to FIGS. 3 and 4 for a disassembling tool of the present invention. The disassembling tool 20 comprises a first member 23 and a second member 24 pivotally connected with each other through a pin 21. A plurality of semicircular first recesses 25, 26 are provided at surfaces 231, 241 of the first and second members 23, 24 facing each other. Each of the first recesses 25, 26 is opened at two laterals of the first member 23 or the second member 24. Thus, when the first member 23 and the second member 24 are drawn together with the first recesses 25, 26 thereon combined mutually, each two said combined first recesses 25, 26 form an air-hose hole 51 (as shown in FIG. 5). The pin 21 is received in pivot holders 31, 32 at rear ends 233, 243 of the first member 23 and the second member 24, so that the first member 23 and the second member 24 are allowed to pivot against the pin 21 and move with respect to each other. A pair of second recesses 27, 28 are lengthwise provided at the surfaces 231, 241 of the first member 23 and the second member 24. Each of the second recesses 27, 28 has one end opened at a front end 234 or 244 of the first member 23 or the second member 24 and an opposite end opened to the adjacent first recess 25 or 26.

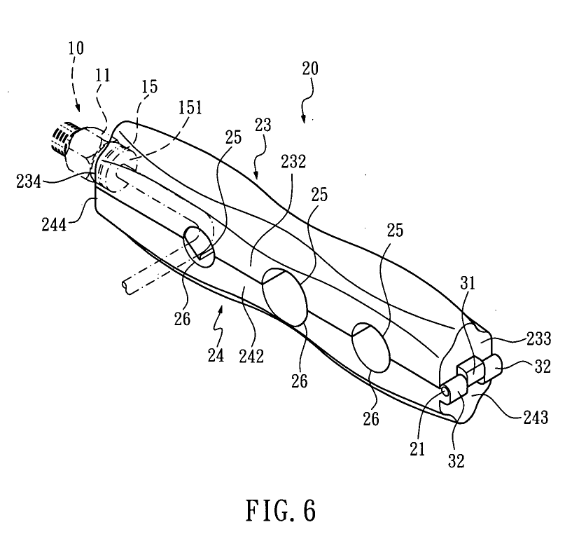

In the first member 23 and the second member 24, the two laterals 232, 242 and surfaces of the front ends 233, 243 are perpendicular to the surfaces 231 and 232 so that the two laterals 232, 242 and surfaces of the front ends 233, 243 act as pressing surfaces to push the ejection member 15 (as shown in FIG. 6). Magnets 40 are settled in the first member 23 and the second member 24 near the front ends 233, 243 thereof so as to hold the first member 23 and the second member 24 together with magnetism.

According to the present embodiment, each of the first member 23 and the second member 24 had three said first recesses 25 or 26 and one said second recess 27 or 28. The three first recesses 25 or 26 of the same member 23 or 24 may be formed into different sizes so that the resulting air-hose holes 51 can be formed for matching the air hose 16 of different diameters. Meanwhile, the second recesses 27 and 28 are diametrically smaller than the first recesses 25 and 26 having the smallest size.

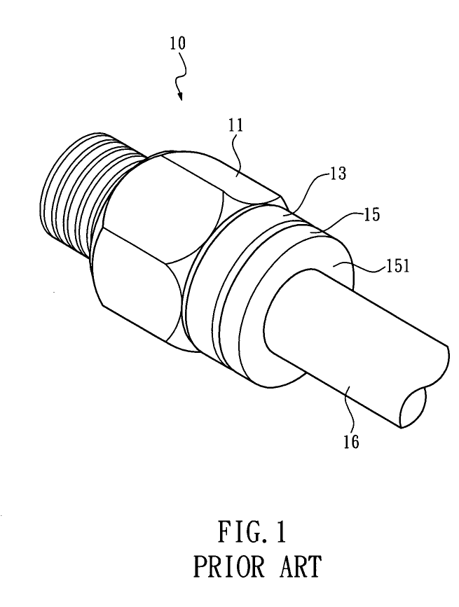

The joint 10 of the air compressor as depicted in FIG. 1 and described with respect to the prior art reappears in FIGS. 5 and 6 for explaining how the disclosed disassembling tool 20 works.

Referring to FIG. 5, in a first operation mode of the disassembling tool 20 to disassemble the air hose 16, the first member 23 and the second member 24 are firstly pulled apart so that the air hose 16 can be put between the first member 23 and the second member 24 parallel with the first recesses 25, 26. Then the air hose 16 is settled in one said pair of first recesses 25, 26 that match the air hose 16 in diameter. Afterward, when the first member 23 and the second member 24 are drawn back together, the magnets 40 make the first member 23 and the second member 24 stay together under magnetic attraction. At this time, an operator can use one hand to push the disassembling tool 20 toward the ejection member 15 along the direction indicated by the arrow A in FIG. 5 to make the lateral 242 or 232 touch and then push the annular surface 151 of the ejection member 15 so as to thrust the ejection member 15 move toward the positioning member 13, and use the other hand to pull out the air hose 16.

Referring to FIG. 6, in a second operation mode of the disassembling tool 20 to disassemble the air hose 16, the first member 23 and the second member 24 are firstly pulled apart and the front ends 234, 244 are aligned to the ejection member 15 so that the air hose 16 can be received in the second recesses 27, 28 and then led out by the first recesses 25, 26 that are intercommunicated second recesses 27, 28. Afterward, when the first member 23 and the second member 24 are drawn back together, the magnets 40 make the first member 23 and the second member 24 stay together under magnetic attraction. At this time, an operator can use one hand to push the disassembling tool 20 toward the ejection member 15 to make the front ends 234, 244 touch and then push the annular surface 151 of the ejection member 15 so as to thrust the ejection member 15 move toward the positioning member 13, and use the other hand to pull out the air hose 16.

The tool 20 of present invention features for it compactness. The tool 20 implements its lateral 232 or 242 or front ends 234, 244 to press the whole annular surface 151 of the ejection member 15, so that the pressing force from the operator can evenly distributed over the ejection member 15, thereby ensuing linear movement of the ejection member 15. As a result, internal components of the joint originally engage the air hose 16 can completely free the air hose 16, and thus the air hose 16 can be easily pulled out. Thereby, the operator can easily disassemble the air hose 16 even when the air compressor is actuated and the air pressure in the air hose 16 gets increased, so that the joint 10 and the air hose 16 are better protected from being damaged under forced disassembling operation.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A disassembling tool for disassembling an air hose from a joint of an air compressor, the disassembling tool comprising:
a first member and a second member pivotally connected with each other through a pin, a plurality of semicircular first recesses being provided at surfaces of the first and second members facing each other, wherein each of the first recesses is opened at two laterals of the first member or the second member, whereby when the first member and the second member are drawn together with the first recesses thereon combined mutually, each two said combined first recesses form an air-hose hole.

2. The disassembling tool of claim 1, wherein the laterals of the first member and the second member are perpendicular to the surfaces of the first member and the second member facing each other.

3. The disassembling tool of claim 1, wherein the pin is received in pivot holders formed at rear ends of the first member and the second member.

4. The disassembling tool of claim 1, further comprising a pair of second recesses that are lengthwise provided at the surfaces of the first member and the second member facing each other, and each of the second recesses has one end opened at a front end of the first member or the second member and an opposite end opened intercommunicated with the adjacent first recess.

5. The disassembling tool of claim 1, wherein the laterals of the first member and the second member are perpendicular to the surfaces of the first member and the second member facing each other.

6. The disassembling tool of claim 1, wherein magnets are settled in the first member and the second member for holding the first member and the second member together with magnetism.
